(19) United States
(12) Patent Application Publication
(10) Pub. No.: US 2024/0177942 A1
(43) Pub. Date: May 30, 2024

(54) LIQUID COMPONENT FOR ELECTROLYTIC CAPACITOR AND ELECTROLYTIC CAPACITOR

(71) Applicant: Panasonic Intellectual Property Management Co., Ltd., Osaka (JP)

(72) Inventors: YUICHIRO TSUBAKI, Kyoto (JP); KAZUHIRO TAKATANI, Hyogo (JP)

(21) Appl. No.: 18/505,158

(22) Filed: Nov. 9, 2023

(30) Foreign Application Priority Data
Nov. 30, 2022 (JP) 2022-191907

(51) Int. Cl. H01G 9/145; H01G 9/028; H01M 10/0565; H01M 10/0567; H01M 10/0569

(52) U.S. Cl. CPC H01G 9/145; H01G 9/028; H01M 10/0565; H01M 10/0567; H01M 10/0569

(57) ABSTRACT

An electrolytic capacitor includes a capacitor element and a liquid component. The capacitor element includes an anode body that includes a dielectric layer on a surface of the anode body, and a solid electrolyte layer that covers at least a part of a surface of the dielectric layer. The solid electrolyte layer contains a conductive polymer component, and the liquid component contains a chelating agent.

### BACKGROUND

### 1. Technical Field

The present disclosure relates to a liquid component for an electrolytic capacitor and an electrolytic capacitor.

### 2. Description of the Related Art

As a small-sized, large-capacitance capacitor having a low equivalent series resistance (ESR), an electrolytic capacitor is seen as promising, the electrolytic capacitor including an anode body having a dielectric layer on a surface of the anode body, a conductive polymer covering at least a part of the dielectric layer, and an electrolytic solution (for example, WO 2017/056447 A).

### SUMMARY

One aspect of the present disclosure relates to a liquid component for an electrolytic capacitor. The liquid component is used for an electrolytic capacitor including a solid electrolyte layer containing a conductive polymer component. The liquid component includes a chelating agent.

Another aspect of the present disclosure relates to an electrolytic capacitor including a capacitor element and a liquid component. The capacitor element includes an anode body and a solid electrolyte layer. The anode body includes a dielectric layer on a surface of the anode body, and the solid electrolyte layer covers at least a part of a surface of the dielectric layer. The solid electrolyte layer contains a conductive polymer component. The liquid component contains a chelating agent.

According to the present disclosure, a leakage current of an electrolytic capacitor can be reduced.

### BRIEF DESCRIPTION OF THE DRAWINGS

FIG. 1 is a sectional view schematically illustrating an example of an electrolytic capacitor according to one exemplary embodiment of the present disclosure; and

FIG. 2 is a perspective view schematically illustrating a configuration of a wound body.

### DETAILED DESCRIPTIONS OF EMBODIMENT

Prior to the description of the exemplary embodiments of the present disclosure, problems to be solved by the present disclosure are briefly explained.

An electrolytic solution may contain a metal such as iron. The metal is derived from, for example, an oxidizing agent used when a conductive polymer component is produced by a chemical polymerization method. Leakage current may increase due to the influence of the metal in the electrolytic solution.

Hereinafter, an exemplary embodiment of the present disclosure will be described with reference to examples, but the present disclosure is not limited to the examples described below. Although specific numerical values and materials may be provided as examples in description below, other numerical values and materials may be applied as long as the effect of the present disclosure can be obtained. In this specification, the description “numerical value A to numerical value B” includes a numerical value A and a numerical value B, and can be read as “between numerical value A and numerical value B (inclusive)”. In the following description, in a case where lower limits and upper limits related to numerical values of specific physical properties, conditions, or the like are illustrated, any of the illustrated lower limits and any of the illustrated upper limits can be freely combined unless the lower limit is equal to or more than the upper limit. In a case where a plurality of materials are illustrated, one of the materials may be selected and used singly, or two or more of the materials may be used in combination.

In addition, the present disclosure encompasses a combination of matters recited in two or more claims freely selected from a plurality of claims recited in the appended claims. That is, as long as no technical contradiction arises, matters recited in two or more claims freely selected from a plurality of claims recited in the appended claims can be combined.

An electrolytic capacitor according to an exemplary embodiment of the present disclosure includes a capacitor element and a liquid component. The capacitor element includes an anode body that includes a dielectric layer on a surface of the anode body, and a solid electrolyte layer that covers at least a part of the surface of the dielectric layer. The solid electrolyte layer contains a conductive polymer component. The liquid component has permeated in the capacitor element. The liquid component is impregnated at least in the solid electrolyte layer, and is in contact with the solid electrolyte layer (the conductive polymer component) and the dielectric layer.

The liquid component protects the conductive polymer component and suppresses oxidation degradation of the conductive polymer component. A decrease in conductivity due to oxidation degradation of the conductive polymer component is suppressed, and an increase in ESR due to the decrease in conductivity is suppressed. Further, the liquid component repairs a defect portion of the dielectric layer and suppresses an increase in leakage current due to the defect of the dielectric layer.

The liquid component contains a chelating agent. When the liquid component of the electrolytic capacitor contains a metal element, the metal element may form a complex with the chelating agent. A metal ion dissolved in the liquid component is trapped by the chelating agent in this manner, which suppresses an increase in leakage current caused by the metal ion.

The solid electrolyte layer may be formed, for example, by chemically polymerizing a precursor of a conductive polymer component (conjugated polymer component) on the dielectric layer in the presence of an oxidizing agent to produce a conductive polymer component. In this case, in the electrolytic capacitor, a metal element derived from the oxidizing agent may be contained in the liquid component. The anion component of the oxidizing agent may also serve as a dopant described later. In the case of a transition metal-based oxidizing agent, a conductive polymer component having high conductivity is likely to be obtained. When a transition metal is dissolved in the liquid component, the leakage current tends to increase, and thus, the effect of reducing the leakage current because of the chelating agent is remarkably obtained.

The solid electrolyte layer may be formed by bringing a dispersion liquid of a conductive polymer component into contact with the dielectric layer. In this case, in the electrolytic capacitor, a metal element derived from a dispersing device, the oxidizing agent, or the like may be contained in the liquid component.

In the electrolytic capacitor, the metal element contained in the liquid component includes, for example, a transition metal element, and includes at least one selected from the group consisting of iron, nickel, copper, titanium, chromium, manganese, and molybdenum. Since these metal elements are dissolved in the liquid component and the leakage current tends to increase, the effect of reducing the leakage current because of the chelating agent is remarkably obtained.

The content of the metal element in the liquid component may be, for example, more than or equal to 10 mass ppm, and may range from 10 mass ppm to 500,000 mass ppm, inclusive. When the content of the metal element in the liquid component is more than or equal to 10 mass ppm, the leakage current tends to increase due to the metal element, and thus, the effect of reducing the leakage current because of the chelating agent is remarkably obtained. A metal element may be mixed in the liquid component contained in the electrolytic capacitor within the above range because of a factor of a production process (production of the conductive polymer component by a chemical polymerization method using an oxidizing agent, production of a dispersion liquid of the conductive polymer component, and the like) of the electrolytic capacitor. Even when the conductive polymer component (capacitor element) to which the reaction liquid after chemical polymerization adheres is cleaned, a small amount of the metal element adhering to the conductive polymer component (capacitor element) remains, and the metal element in an amount of more than or equal to 10 mass ppm may be mixed into the liquid component. The metal element in an amount of the above range in the liquid component can be sufficiently captured by the chelating agent. For analysis of the metal element in the liquid component, inductively coupled plasma (ICP) emission spectrophotometry, ion chromatography (IC), capillary electrophoresis (CE), or the like may be used.

The chelating agent preferably contains at least one selected from the group consisting of an aminocarboxylic acid-based chelating agent, a hydroxycarboxylic acid-based chelating agent, and a phosphonic acid-based chelating agent.

Examples of the aminocarboxylic acid-based chelating agent include N-(2-hydroxyethyl)ethylenediamine-N,N′,N′-triacetic acid, ethylenediaminetetraacetic acid, diethylenetriaminepentaacetic acid, nitrilotriacetic acid, triethylenetetraminchexaacetic acid, 1,3-propanediamine-N,N,N′,N′-tetraacetic acid, 1,3-diamino-2-hydroxypropane-N,N,N′,N′-tetraacetic acid, N-(2-hydroxyethyl)iminodiacetic acid, N,N-di(2-hydroxyethyl)glycine, and glycol ether diamine tetraacetic acid. One type of the aminocarboxylic acid-based chelating agent may be used singly, or two or more types may be used in combination.

Examples of the hydroxycarboxylic acid-based chelating agent include citric acid, tartaric acid, malic acid, and gluconic acid. One type of the hydroxycarboxylic acid-based chelating agent may be used singly, or two or more types may be used in combination.

Examples of the phosphonic acid-based chelating g agent include hydroxyethanediphosphonic acid, etidronic acid, nitrilotris(methylene phosphonic acid), ethylenediamine tetra(methylene phosphonic acid), and diethylenetriamine penta(methylene phosphonic acid). One type of the phosphonic acid-based chelating agent may be used singly, or two or more types may be used in combination.

A liquid component containing a chelating agent may be prepared, and the capacitor element may be impregnated with the liquid component containing a chelating agent. By adding a chelating agent to the liquid component, the metal element mixed in the liquid component in the production process of the electrolytic capacitor can be efficiently captured with a small amount of the chelating agent. The amount of the chelating agent to be added is preferably small (for example, less than or equal to 30 mass % or less than or equal to 15 mass %) from the viewpoint that the effect of the chelating agent on members such as an electrode assembly can be sufficiently reduced.

From the viewpoint of reducing the leakage current, the content of the chelating agent in the liquid component ranges preferably more than or equal to 0.01 mass %, more preferably from 0.01 mass % (or from 0.1 mass %) to 50 mass %, inclusive, still more preferably from 0.1 mass % to 30 mass % (or to 15 mass %), inclusive. The metal element mixed in the liquid component can be sufficiently captured with a small amount of the chelating agent of less than or equal to 30 mass % or less than or equal to 15 mass %. Even when the conductive polymer component (capacitor element) to which the reaction liquid after chemical polymerization adheres is cleaned, some metal elements may remain. In this case, the leakage current can be reduced with a small amount of the chelating agent of less than or equal to 15 mass % or less than or equal to 10 mass %. The content of the chelating agent in the liquid component is a mass proportion (percentage) of the chelating agent to the entire liquid component at the time of preparation of the liquid component or at the initial stage of the electrolytic capacitor. Ion chromatography (IC) or the like can be used for analysis of the chelating agent in the liquid component.

From the viewpoint of the amount of the oxidizing agent used for producing the conductive polymer component, the content of the chelating agent in the electrolytic capacitor may range from 10 mass ppm to 500,000 mass ppm, inclusive, or from 100 mass ppm to 300,000 mass ppm, inclusive, with respect to the conductive polymer component (for example, a conjugated polymer component doped with a dopant). The metal element mixed in the liquid component can be sufficiently captured with a small amount of the chelating agent with respect to the conductive polymer component. The content of the chelating agent in the electrolytic capacitor is a mass proportion (parts per million) of the chelating agent to the conductive polymer component in the initial stage of the electrolytic capacitor.

The liquid component may contain a chelating agent in a dissolved (or dispersed) state. The liquid component may contain a solvent (non-aqueous solvent). One type of the solvent may be used singly, or two or more types may be used in combination. From the viewpoint of easily securing the permeability of the liquid component into the solid electrolyte layer and the solubility of the chelating agent, the liquid component preferably contains an alcohol-based solvent. The alcohol-based solvent contains at least one of a monohydric alcohol and a polyhydric alcohol (hereinafter, it is also referred to as a polyol-based solvent). The alcohol-based solvent preferably contains a polyol-based solvent.

The polyol-based solvent preferably contains at least one selected from the group consisting of a glycol compound, a glycerin compound, and derivatives thereof. In this case, it is easy to adjust the viscosity of the liquid component containing the first polymer component to be appropriately low, and a high permeability of the liquid component into the capacitor element (solid electrolyte layer) is likely to be obtained. In addition, the orientation of the conductive polymer component is improved by swelling, and the conductivity is likely to be improved. High restorability of the dielectric layer is likely to be obtained.

The glycol compound is preferably, for example, an alkylene glycol having 2 to 8 (or 2 to 6) carbon atoms or a polyalkylene glycol. Examples of the alkylene glycol having 2 to 8 carbon atoms include ethylene glycol, propylene glycol (1,2-propanediol), trimethylene glycol (1,3-propanediol), diethylene glycol, triethylene glycol, and tetracthylene glycol. Examples of the polyalkylene glycol include polyethylene glycol, polypropylene glycol, and a copolymer of ethylene glycol and propylene glycol. The weight-average molecular weight of the ethylene glycol is, for example, less than or equal to 1000 from the viewpoint of the viscosity of the liquid component, and may range from 300 to 1000, inclusive, from the viewpoint of suppressing volatilization. The weight-average molecular weight of the polypropylene glycol is, for example, less than or equal to 5000 from the viewpoint of the viscosity of the liquid component, and may range from 200 to 5000, inclusive, from the viewpoint of suppressing volatilization.

Among them, the glycol compound is preferably ethylene glycol, diethylene glycol, triethylene glycol, tetraethylene glycol, or polyethylene glycol. One type of the glycol compound may be used singly, or two or more types may be used in combination.

Examples of the derivative of the glycol compound include a compound in which one or both terminals of the main chain of the polyalkylene glycol are etherified or esterified. The etherified terminal may be, for example, a —OR group. The esterified terminal may be, for example, a —OC(═O)R group. R is an organic group such as an alkyl group.

Examples of the glycerin compound include glycerin and polyglycerin. One type of the glycerin compound may be used singly, or two or more types may be used in combination.

The proportion of the alcohol-based solvent in the entire solvent contained in the liquid component may be more than or equal to 50 mass %, more than or equal to 80 mass %, or 100 mass %. The liquid component may contain a solvent other than the alcohol-based solvent. Examples of the solvent other than the alcohol-based solvent include a sulfone compound, a lactone compound, and a carbonate compound.

Examples of the sulfone compound include sulfolane, dimethyl sulfoxide, and diethyl sulfoxide. Examples of the lactone compound include γ-butyrolactone and γ-valerolactone. Examples of the carbonate compound include dimethyl carbonate, diethyl carbonate, ethyl methyl carbonate, ethylene carbonate, propylene carbonate, and fluoroethylene carbonate.

The liquid component may contain a solute. That is, the liquid component may be an electrolytic solution containing a solvent and a solute. Examples of the solute include an acid component and a base component. The liquid component preferably contains an acid component. When the conductive polymer component contains a dopant, the acid component in the liquid component suppresses a dedoping phenomenon of the dopant and stabilizes conductivity of the conductive polymer component. Even when the dopant is dedoped from the conductive polymer component, the ESR is likely to be maintained low since a dedoped site is re-doped with the acid component.

It is desirable that the acid component in the liquid component does not excessively increase the viscosity of the liquid component, and generates an anion that easily dissociates in the liquid component and easily moves in the solvent. Examples of such an acid component include aliphatic sulfonic acids having 1 to 30 carbon atoms and aromatic sulfonic acids having 6 to 30 carbon atoms. As the aliphatic sulfonic acid, monovalent saturated aliphatic sulfonic acid (e.g., hexanesulfonic acid) is preferable. As the aromatic sulfonic acid, an aromatic sulfonic acid having a hydroxy group or a carboxy group in addition to a sulfo group is preferable, and specifically, an oxyaromatic sulfonic acid (e.g., phenol-2-sulfonic acid) and a sulfoaromatic carboxylic acid (e.g., p-sulfobenzoic acid, 3-sulfophthalic acid, or 5-sulfosalicylic acid) are preferable.

Examples of other acid components include a carboxylic acid. The carboxylic acid preferably contains an aromatic carboxylic acid having two or more carboxyl groups (aromatic dicarboxylic acid). Examples of the aromatic carboxylic acid include phthalic acid (ortho form), isophthalic acid (meta form), terephthalic acid (para form), maleic acid, benzoic acid, salicylic acid, trimellitic acid, and pyromellitic acid. In particular, aromatic dicarboxylic acid such as phthalic acid (ortho form) or maleic acid is more preferable. The carboxyl group of the aromatic dicarboxylic acid is stable and is less likely to cause a side reaction to proceed. This causes an effect of stabilizing the conductive polymer component to be exhibited over a long period of time, which is advantageous in prolonging the life of the electrolytic capacitor. The carboxylic acid may be an aliphatic carboxylic acid such as adipic acid.

The acid component may contain a composite compound of an organic acid and an inorganic acid in terms of thermal stability. Examples of the composite compound of an organic acid and an inorganic acid include borodisalicylic acid, borodioxalic acid, and borodiglycolic acid that have high heat resistance. The acid component may include an inorganic acid such as boric acid, phosphoric acid, phosphorous acid, hypophosphorous acid, or phosphonic acid.

From the viewpoint of enhancing an effect of suppressing the dedoping phenomenon, the concentration of the acid component may range from 5 mass % to 50 mass %, inclusive, or may range from 15 mass % to 35 mass %, inclusive.

The liquid component may contain a base component together with an acid component. At least a part of the acid component is neutralized by the base component. This can suppress corrosion of an electrode due to the acid component while increasing the acid component in concentration. From the viewpoint of effectively suppressing dedoping, the acid component is preferably more excessive than the base component in terms of equivalent ratio. For example, the equivalent ratio of the acid component to the base component may range from 1 to 30, inclusive. The concentration of the base component contained in the liquid component may range from 0.1 mass % to 20 mass %, inclusive, or may range from 3 mass % to 10 mass %, inclusive.

The base component is not particularly limited. Examples of the base component include ammonia, primary amine, secondary amine, tertiary amine, a quaternary ammonium compound, and an amidinium compound. Examples of each amine include aliphatic amine, aromatic amine, and heterocyclic amine. Examples of the amine include trimethylamine, diethylamine, ethyldimethylamine, triethylamine, ethylenediamine, aniline, pyrrolidine, imidazole (e.g., 1,2,3,4-tetramethylimidazolinium), and 4-dimethylaminopyridine. Examples of the quaternary ammonium compound include amidine compounds (also containing imidazole compounds).

The pH of the liquid component is preferably less than or equal to 4, more preferably less than or equal to 3.8, still more preferably less than or equal to 3.6. When the pH of the liquid component is less than or equal to 4, deterioration of the conductive polymer component is further suppressed. The pH is preferably more than or equal to 2.

### (Capacitor Element)

The capacitor element includes an anode body that includes a dielectric layer on a surface of the anode body and a solid electrolyte layer that covers a part of the dielectric layer. The solid electrolyte layer contains a conductive polymer component.

### (Anode Body)

The anode body may include a valve metal, an alloy containing the valve metal, and a compound containing the valve metal. These materials may be used singly or in combination of two or more thereof. Preferably available examples of the valve metal include aluminum, tantalum, niobium, and titanium. The anode body having a porous surface is obtained, for example, by roughening a surface of a base material (such as a foil-shaped or plate-shaped base material) containing the valve metal by etching or the like. The anode body may be a molded body of particles containing the valve metal or a sintered body thereof. The sintered body has a porous structure.

### (Dielectric Layer)

The dielectric layer is formed by anodizing the valve metal of the surface of the anode body by anodizing treatment or the like. The dielectric layer covers at least a part of the anode body. Usually, the dielectric layer is formed on the surface of the anode body. Since the dielectric layer is formed on a porous surface of the anode body, the dielectric layer is formed along inner wall surfaces of holes and hollows (pits) in the surface of the anode body.

The dielectric layer contains an oxide of the valve metal. For example, when tantalum is used as the valve metal, the dielectric layer contains Ta₂O₅, and when aluminum is used as the valve metal, the dielectric layer contains Al₂O₃. The dielectric layer is not limited to the ones described above, and any dielectric layer may be used as long as the dielectric layer functions as a dielectric body. When the anode body has a porous surface, the dielectric layer is formed along the surface of the anode body (including inner wall surfaces of holes).

### (Solid Electrolyte Layer)

The solid electrolyte layer covers at least a part of the dielectric layer. The solid electrolyte layer contains a conductive polymer component. The solid electrolyte layer may be formed by attaching the conductive polymer component to at least a part of the surface of the dielectric layer. The conductive polymer component may further contain an additive agent as necessary. The conductive polymer component may be further attached to the surface of an anode/cathode body or a separator described later.

The conductive polymer component contains, for example, a conjugated polymer component. Examples of the conjugated polymer component include known conjugated polymer components used in electrolytic capacitors, such as x-conjugated polymer components. Examples of the conjugated polymer component include polymer components having polypyrrole, polythiophene, polyaniline, polyfuran, polyacetylene, polyphenylene, polyphenylene vinylene, polyacene, and polythiophene vinylene as a basic skeleton. The polymer component is required to contain at least one type of monomer unit constituting the basic skeleton. The polymer component also contains a homopolymer, a copolymer of two or more types of monomers, and derivatives of these polymers (a substitution product having a substituent group or the like). For example, polythiophene contains poly(3,4-ethylenedioxythiophene) and the like. As the conjugated polymer component, one type may be used singly, or two or more types may be used in combination.

A weight-average molecular weight (Mw) of the conjugated polymer component is not particularly limited and ranges, for example, from 1,000 to 1,000,000, inclusive. The weight-average molecular weight (Mw) is a value in terms of polystyrene measured by gel permeation chromatography (GPC). The GPC is typically measured using a polystyrene gel column, and water and methanol (volume ratio: 8/2) as a mobile phase.

The conjugated polymer component may be doped with a dopant. That is, the conductive polymer component may contain a conjugated polymer component doped with a dopant.

Examples of the dopant include relatively low molecular anions and polymeric anions. Examples of the anion include a sulfate ion, a nitrate ion, a phosphate ion, a borate ion, a sulfonate ion, and a carboxylate ion. Compounds that produce these anions are used as dopants. Examples of the sulfonic acid include alkyl sulfonic acids and aromatic sulfonic acids. Examples of the aromatic sulfonic acid include p-toluenesulfonic acid and naphthalenesulfonic acid. The anion component of the oxidizing agent may also serve as a dopant. Examples of the oxidizing agent also serving as a dopant include a sulfonic acid-based metal salt. Examples of the sulfonic acid-based metal salt include ferric p-toluenesulfonate.

A polymeric sulfonic acid may be used as the dopant that generates sulfonate ions. Examples of the polymeric sulfonic acid include polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), and polyisoprenesulfonic acid. The polymeric anion may be a polymer of a single monomer, a copolymer of two or more monomers, or a substitution product having a substituent. Among them, a polyanion derived from polystyrenesulfonic acid is preferable. One type of the dopant may be used singly, or two or more types may be used in combination.

The solid electrolyte layer (conductive polymer component) may be formed, for example, by performing at least one of chemical polymerization and electrolytic polymerization of a precursor of the conjugated polymer component on the dielectric layer in the presence of a dopant. Alternatively, the solid electrolyte layer may be formed by bringing a dispersion liquid (or solution) of the conductive polymer component into contact with the dielectric layer. The conductive polymer component to be dispersed (dissolved) in a dispersion medium (solvent) may be obtained, for example, by polymerizing a precursor of the conjugated polymer component in the presence of a dopant. Examples of the precursor of the conjugated polymer component include a raw material monomer of the conjugated polymer component, and an oligomer and a prepolymer in which a plurality of molecular chains of the raw material monomer are linked. One type of the precursor may be used, or two or more types may be used in combination.

The content of the dopant ranges, for example, from 10 parts by mass to 1000 parts by mass, inclusive, and may range from 20 parts by mass to 500 parts by mass, inclusive, or from 50 parts by mass to 200 parts by mass, inclusive, with respect to 100 parts by mass of the conjugated polymer component.

### (Cathode Body)

A cathode body may be used, and a metal foil may be used for the cathode body, as in the case of the anode body. The type of the metal is not particularly limited, but it is preferable to use a valve metal such as aluminum, tantalum, or niobium or an alloy containing the valve metal. The surface of the metal foil may be roughened as necessary. The surface of the metal foil may be provided with an anodization film, and may be provided with a film of metal (dissimilar metal) different from the metal constituting the metal foil, or a nonmetal film. Examples of the dissimilar metal and the nonmetal include metals such as titanium and nonmetals such as carbon.

### (Separator)

When a metal foil is used for the cathode body, a separator may be disposed between the metal foil and the anode body. The separator is not particularly limited. For example, an unwoven fabric including fibers of cellulose, polyethylene terephthalate, vinylon, or polyamide (for example, aliphatic polyamide or aromatic polyamide such as aramid) or the like may be used.

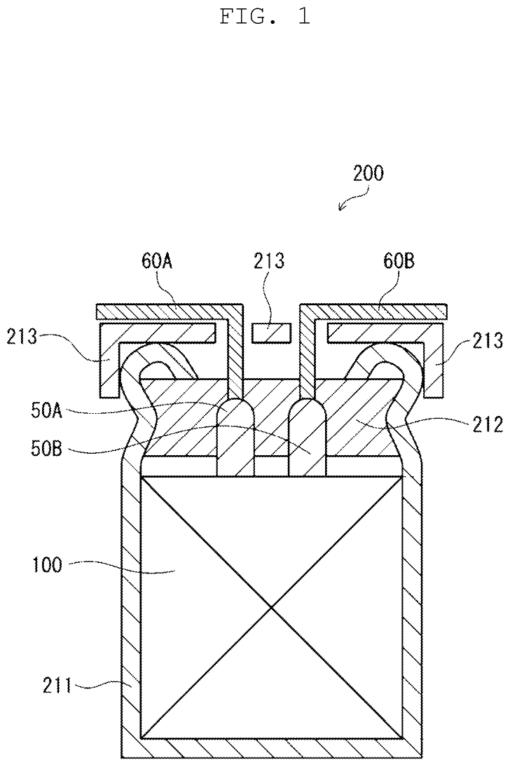

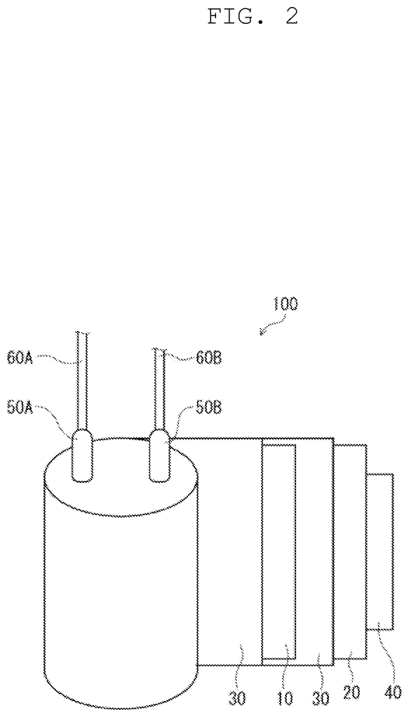

Here, FIG. 1 is a sectional view schematically illustrating an electrolytic capacitor according to one exemplary embodiment of the present disclosure. FIG. 2 is a perspective view schematically illustrating a configuration of a wound body.

Electrolytic capacitor 200 includes a capacitor element and a liquid component (not illustrated). The capacitor element includes wound body 100 and a solid electrolyte layer (not illustrated). Wound body 100 is formed by winding anode body 10 having a dielectric layer on a surface of anode body 10 and cathode body 20 with separator 30 interposed therebetween. The solid electrolyte layer covers at least a part of the surface of anode body 10 (dielectric layer). The capacitor element (at least the solid electrolyte layer) is impregnated with the liquid component.

Winding stop tape 40 is disposed on an outer surface of cathode body 20 positioned at an outermost layer of wound body 100, and an end portion of cathode body 20 is fixed by winding stop tape 40. When anode body 10 is prepared by cutting a large foil, an anodizing treatment may further be performed on wound body 100 in order to provide a dielectric layer on a cutting surface.

One ends of lead tabs 50A and 50B are connected to anode body 10 and cathode body 20, respectively. Lead wires 60A and 60B are connected to the other ends of lead tabs 50A and 50B, respectively.

The capacitor element and the liquid component are housed in bottomed case 211. As a material of bottomed case 211, a metal such as aluminum, stainless steel, copper, iron, or brass, or an alloy thereof may be used.

Sealing member 212 is disposed at an opening of bottomed case 211, an opening end of bottomed case 211 is caulked to sealing member 212 to be curled, and base plate 213 is disposed at a curled portion, whereby the capacitor element and the liquid component are sealed in bottomed case 211.

Lead wires 60A, 60B penetrate the sealing member 212. Sealing member 212 may be an insulating substance, and is preferably an elastic body. Among these materials, silicone rubber, fluororubber, ethylene propylene rubber, Hypalon rubber, butyl rubber, isoprene rubber, or the like, having high heat resistance, is preferable.

The electrolytic capacitor may be a wound type, or may be either a chip type or a stack type. A chip-type or stack-type electrolytic capacitor may include a conductive layer (a carbon layer and a silver paste layer) covering the solid electrolyte layer. The electrolytic capacitor may include at least one capacitor element, and may include a plurality of capacitor elements. For example, the electrolytic capacitor may include a stack of two or more capacitor elements, or may include two or more wound-type capacitor elements. The configuration or number of the capacitor elements may be selected according to the type or use of the electrolytic capacitor.

### Examples

Hereinafter, the present disclosure will be described in more detail based on Examples, but the present disclosure is not limited to Examples.

<<Electrolytic capacitors A1 to A3>>

In the present Example, produced was a wound-type electrolytic capacitor (diameter 8.0 mm×length 12.0 mm) having a rated voltage of 35 V and a rated capacitance of 22 μF. A specific method for producing the electrolytic capacitor will be described below.

### (Production of Anode Body)

An aluminum foil having a thickness of 100 μm was subjected to an etching treatment to roughen the surface of the aluminum foil. Thereafter, a dielectric layer was formed on the surface of the aluminum foil by an anodizing treatment. The anodizing treatment was performed by immersing the aluminum foil in an ammonium adipate solution, followed by application of a voltage of 60 V. Thereafter, the aluminum foil was cut into a predetermined size to obtain an anode body.

### (Production of Cathode Body)

An aluminum foil having a thickness of 50 μm was subjected to an etching treatment to roughen the surface of the aluminum foil. Thereafter, the aluminum foil was cut into a predetermined size to obtain a cathode body.

### (Production of Wound Body)

An anode lead tab and a cathode lead tab to which lead wires were connected were respectively connected to the anode body and the cathode body, and the anode body and the cathode body were wound with the separator interposed between the anode body and the cathode body and while the lead tabs were being wound. Then, the formed wound body was subjected to the anodizing treatment again to form a dielectric layer on the cutting end of the anode body. Next, the end part of the outer surface of the wound body was fixed with a winding stop tape, whereby the wound body was produced.

### (Preparation of Polymerization Liquid)

A polymerization liquid was obtained by adding 3,4-ethylenedioxythiophene (EDOT) as a precursor (monomer) of the conductive polymer to a mixed liquid containing ferric p-toluenesulfonate (oxidizing agent) and ethanol (solvent). In the polymerization liquid, the mass ratio of solvent:oxidizing agent:monomer was 50:30:20.

### (Formation of Solid Electrolyte Layer)

The wound body was immersed in the polymerization liquid for about 3 to 10 seconds, then the wound body was picked up from the polymerization liquid, and the wound body was heated at 210° C. for 3 minutes to produce polyethylene dioxythiophene (PEDOT) through oxidative polymerization. In this manner, solid electrolyte layer containing PEDOT (conjugated polymer component) and p-toluenesulfonic acid (dopant) was formed, and a capacitor element was produced.

### (Preparation of Liquid Component)

A chelating agent was added to an electrolytic solution containing ethylene glycol (solvent) and triethylamine phthalate (solute) to prepare a liquid component. The concentration of triethylamine phthalate in the electrolytic solution was 10 mass %. The content of the chelating agent in the liquid component was 0.5 mass %. As the chelating agent, the compounds shown in Table 1 were used.

### (Assembling of Electrolytic Capacitor)

The capacitor element was immersed in the liquid component in a decompressed atmosphere (40 kPa) for 5 minutes to impregnate the capacitor element with the liquid component. Thereafter, the capacitor element was housed in a bottomed case, and a sealing member was disposed in the opening of the bottomed case to seal the capacitor element. The bottomed case was drawn in the vicinity of the opening end, the opening end was curled, and a base plate was disposed at the curled portion. An electrolytic capacitor having the structure shown in FIG. 1 was thus completed. Thereafter, an aging treatment was performed at 130° C. for 2 hours while a rated voltage was applied to the electrolytic capacitor.

### <<Electrolytic Capacitor B1>>

Electrolytic capacitor B1 was produced in the same manner as in electrolytic capacitor A1 except that a chelating agent was not added to the electrolytic solution in the preparation of the liquid component.

### [Evaluation: Measurement of Leakage Current]

A rated voltage was applied to the electrolytic capacitor under an environment of 20° C., and a leakage current (initial leakage current) after a lapse of 2 minutes was measured.

Evaluation results are shown in Table 1. In Table 1, A1 to A3 are Examples, and B1 is Comparative Example.

TABLE 1

| | Liquid component | | | Initial |
|---|---|---|---|---|
| | Chelating agent | | | LC |
| Electrolytic | | Content | | value |
| capacitor | Compound | (mass %) | Solvent | (μA) |
| A1 | Hydroxyethanediphosphonic acid | 30 | Ethylene glycol | 0.7 |
| A2 | Ethylenediaminetetraacetic acid | 30 | Ethylene glycol | 2.8 |
| A3 | Gluconic acid | 30 | Ethylene glycol | 1.7 |
| B1 | — | — | Ethylene glycol | 36378 |

In electrolytic capacitor B1 in which a chelating agent was not contained in the liquid component, iron derived from ferric p-toluenesulfonate (oxidizing agent) was dissolved in the liquid component, and the LC value increased. The iron content in the liquid component in electrolytic capacitor B1 after aging was within a range of from 100,000 to 150,000 mass ppm.

Also in electrolytic capacitors A1 to A3, almost the same amount of iron as in the case of electrolytic capacitor B1 was contained in the liquid component, but most of iron was trapped by the chelating agent, and thus, the LC values were significantly reduced in electrolytic capacitors A1 to A3.

### <<Electrolytic Capacitors A4 to A9>>

Electrolytic capacitors A4 to A9 were produced and evaluated in the same manner as in electrolytic capacitor A1 except that the content of the chelating agent in the liquid component was changed to the value shown in Table 2.

The evaluation results are represented in Table 2. In Table 2, A4 to A9 are Examples. Table 2 also shows evaluation results of electrolytic capacitor A1.

TABLE 2

| | Liquid component | | | Initial |
|---|---|---|---|---|
| | Chelating agent | | | LC |
| Electrolytic | | Content | | value |
| capacitor | Compound | (mass %) | Solvent | (μA) |
| A4 | Hydroxyethanediphosphonic acid | 0.01 | Ethylene glycol | 2570 |
| A5 | Hydroxyethanediphosphonic acid | 0.1 | Ethylene glycol | 7.9 |
| A1 | Hydroxyethanediphosphonic acid | 1 | Ethylene glycol | 1.9 |
| A6 | Hydroxyethanediphosphonic acid | 5 | Ethylene glycol | 0.9 |
| A7 | Hydroxyethanediphosphonic acid | 15 | Ethylene glycol | 0.6 |
| A8 | Hydroxyethanediphosphonic acid | 30 | Ethylene glycol | 0.7 |
| A9 | Hydroxyethanediphosphonic acid | 50 | Ethylene glycol | 18.7 |

In any of the electrolytic capacitors, the LC value was reduced as compared with electrolytic capacitor B1. In particular, in electrolytic capacitors A1 and A5 to A9 in which the content of the chelating agent in the liquid component ranged from 0.1 mass % to 50 mass %, inclusive, the LC value was significantly reduced. In electrolytic capacitors A1 and A5 to A9, in the capacitor element impregnated with the liquid component, the proportion (parts per million) of the chelating agent to the conductive polymer component was in the range of from 100 mass ppm to 500,000 mass ppm, inclusive.

### <<Note>>

The above description of the exemplary embodiments discloses the following technologies.

### (Technology 1)

A liquid component for an electrolytic capacitor, the liquid component being used for an electrolytic capacitor including a solid electrolyte layer containing a conductive polymer component, the liquid component including a chelating agent.

### (Technology 2)

The liquid component according to Technology 1, wherein the chelating agent contains at least one selected from the group consisting of an aminocarboxylic acid-based chelating agent, a hydroxycarboxylic acid-based chelating agent, and a phosphonic acid-based chelating agent.

### (Technology 3)

The liquid component according to Technology 2, wherein the aminocarboxylic acid-based chelating agent contains at least one selected from the group consisting of N-(2-hydroxyethyl)ethylenediamine-N,N′,N′-triacetic acid, ethylenediaminetetraacetic acid, diethylenetriaminepentaacetic acid, nitrilotriacetic acid, triethylenetetraminehexaacetic acid, 1,3-propanediamine-N,N,N′,N′-tetraacetic acid, 1,3-diamino-2-hydroxypropane-N,N,N′,N′-tetraacetic acid, N-(2-hydroxyethyl)iminodiacetic acid, N,N-di(2-hydroxyethyl)glycine, and glycol ether diamine tetraacetic acid.

### (Technology 4)

The liquid component according to Technology 2, wherein the hydroxycarboxylic acid-based chelating agent contains at least one selected from the group consisting of citric acid, tartaric acid, malic acid, gluconic acid, salicylic acid, and resorcylic acid.

### (Technology 5)

The liquid component according to Technology 2, wherein the phosphonic acid-based chelating agent contains at least one selected from the group consisting of hydroxyethanediphosphonic acid, nitrilotris(methylenephosphonic acid), ethylenediaminetetra(methylenephosphonic acid), and diethylenetriaminepenta(methylenephosphonic acid).

### (Technology 6)

The liquid component according to any one of Technologies 1 to 5, further including an alcohol-based solvent.

### (Technology 7)

The liquid component according to Technology 6, wherein the alcohol-based solvent contains at least one selected from the group consisting of a glycol compound, a glycerin compound, and a derivative thereof.

### (Technology 8)

The liquid component according to Technology 7, wherein the alcohol-based solvent contains at least one selected from the group consisting of ethylene glycol, diethylene glycol, triethylene glycol, tetraethylene glycol, polyethylene glycol, glycerin, polyglycerin, and a derivative thereof.

### (Technology 9)

The liquid component according to any one of Technologies 1 to 8, wherein a content of the chelating agent in the liquid component ranges from 0.01 mass % to 50 mass %, inclusive.

### (Technology 10)

An electrolytic capacitor including:
a capacitor element; and
a liquid component,
wherein:
the capacitor element includes an anode body and a solid electrolyte layer, the anode body including a dielectric layer on a surface of the anode body, the solid electrolyte layer covering at least a part of a surface of the dielectric layer,
the solid electrolyte layer contains a conductive polymer component, and
the liquid component contains a chelating agent.

### (Technology 11)

The electrolytic capacitor according to Technology 10, wherein a content of the chelating agent ranges from 10 mass ppm to 500,000 mass ppm, inclusive, with respect to the conductive polymer component.

### (Technology 12)

The electrolytic capacitor according to Technology 10 or 11, wherein:
the liquid component contains a metal element, and
the metal element forms a complex with the chelating agent.

### (Technology 13)

The electrolytic capacitor according to Technology 12, wherein:
the conductive polymer component is obtained by a chemical polymerization method using an oxidizing agent, and
the metal element is derived from the oxidizing agent.

### (Technology 14)

The electrolytic capacitor according to Technology 12 or 13, wherein the metal element includes at least one selected from the group consisting of iron, nickel, copper, titanium, chromium, manganese, and molybdenum.

### (Technology 15)

The electrolytic capacitor according to any one of Technologies 12 to 14, wherein a content of the metal element in the liquid component is more than or equal to 10 mass ppm.

The liquid component for an electrolytic capacitor according to the present disclosure is suitably used for an electrolytic capacitor in which reduction of leakage current is required.

What is claimed is:

1. A liquid component for an electrolytic capacitor, the liquid component being used for the electrolytic capacitor including a solid electrolyte layer containing a conductive polymer component,
the liquid component comprising a chelating agent.

2. The liquid component according to claim 1, wherein the chelating agent contains at least one selected from the group consisting of an aminocarboxylic acid-based chelating agent, a hydroxycarboxylic acid-based chelating agent, and a phosphonic acid-based chelating agent.

3. The liquid component according to claim 2, wherein the aminocarboxylic acid-based chelating agent contains at least one selected from the group consisting of N-(2-hydroxyethyl)ethylenediamine-N,N′,N′-triacetic acid, ethylenediaminetetraacetic acid, diethylenetriaminepentaacetic acid, nitrilotriacetic acid, triethylenetetraminehexaacetic acid, 1,3-propanediamine-N,N,N′,N′-tetraacetic acid, 1,3-diamino-2-hydroxypropane-N,N,N′,N′-tetraacetic acid, N-(2-hydroxyethyl)iminodiacetic acid, N,N-di(2-hydroxyethyl)glycine, and glycol ether diamine tetraacetic acid.

4. The liquid component according to claim 2, wherein the hydroxycarboxylic acid-based chelating agent contains at least one selected from the group consisting of citric acid, tartaric acid, malic acid, gluconic acid, salicylic acid, and resorcylic acid.

5. The liquid component according to claim 2, wherein the phosphonic acid-based chelating agent contains at least one selected from the group consisting of hydroxyethanediphosphonic acid, nitrilotris(methylenephosphonic acid), ethylenediaminetetra(methylenephosphonic acid), and diethylenetriaminepenta(methylenephosphonic acid).

6. The liquid component according to claim 1, further comprising an alcohol-based solvent.

7. The liquid component according to claim 6, wherein the alcohol-based solvent contains at least one selected from the group consisting of a glycol compound, a glycerin compound, and a derivative thereof.

8. The liquid component according to claim 7, wherein the alcohol-based solvent contains at least one selected from the group consisting of ethylene glycol, diethylene glycol, triethylene glycol, tetraethylene glycol, polyethylene glycol, glycerin, polyglycerin, and a derivative thereof.

9. The liquid component according to claim 1, wherein a content of the chelating agent in the liquid component ranges from 0.01 mass % to 50 mass %, inclusive.

10. An electrolytic capacitor comprising:
a capacitor element; and
a liquid component,
wherein:
the capacitor element includes an anode body and a solid electrolyte layer, the anode body including a dielectric layer on a surface of the anode body, the solid electrolyte layer covering at least a part of a surface of the dielectric layer,
the solid electrolyte layer contains a conductive polymer component, and
the liquid component contains a chelating agent.

11. The electrolytic capacitor according to claim 10, wherein a content of the chelating agent ranges from 10 mass ppm to 500,000 mass ppm, inclusive, with respect to the conductive polymer component.

12. The electrolytic capacitor according to claim 10, wherein:
the liquid component contains a metal element, and
the metal element forms a complex with the chelating agent.

13. The electrolytic capacitor according to claim 12, wherein:
the conductive polymer component is obtained by a chemical polymerization method using an oxidizing agent, and
the metal element is derived from the oxidizing agent.

14. The electrolytic capacitor according to claim 12, wherein the metal element includes at least one selected from the group consisting of iron, nickel, copper, titanium, chromium, manganese, and molybdenum.

15. The electrolytic capacitor according to claim 12, wherein a content of the metal element in the liquid component is more than or equal to 10 mass ppm.
